(19) United States
(12) Patent Application Publication
(10) Pub. No.: US 2021/0102090 A1
(43) Pub. Date: Apr. 8, 2021

(54) FORMATION OF COATINGS BY SEPARATE APPLICATION OF POLYISOCYANATE COMPOSITIONS AND CROSSLINKING CATALYSTS

(71) Applicant: Covestro Deutschland AG, Leverkusen (DE)

(72) Inventors: Jörg TILLACK, Solingen (DE); Dirk ACHTEN, Leverkusen (DE); Cornelia STECK, Oberhausen (DE); Roland WAGNER, Leverkusen (DE)

(21) Appl. No.: 16/498,551

(22) PCT Filed: Mar. 28, 2018
(86) PCT No.: PCT/EP2018/057917

§ 371 Date: Sep. 27, 2019

(30) Foreign Application Priority Data
Mar. 29, 2017 (EP) 17163485.0

(51) Int. Cl. C09D 179/04; B05D 3/02; B05D 3/10

(52) U.S. Cl. CPC C09D 179/04; B05D 3/105; B05D 3/0209; B05D 3/0254

(57) ABSTRACT

The invention relates to processes for coating surfaces by alternatingly applying polyisocyanate compositions and suitable crosslinking catalysts, followed by catalytically crosslinking the polyisocyanate composition.

The present invention relates to a process for coating surfaces by alternating application of polyisocyanate compositions and suitable crosslinking catalysts followed by catalytic crosslinking of the polyisocyanate composition. Crosslinking is preferably effected without the involvement of polyols, polyamines or polythiols.

U.S. Pat. No. 6,133,397 describes the catalytic crosslinking of polyisocyanates for the construction of coatings. However, the catalyst and the polyisocyanate are mixed before application to the surface to be coated.

It has surprisingly been found in the study underlying the present patent application that stable coatings having advantageous performance properties are obtainable even when the crosslinking catalyst and the polyisocyanate to be crosslinked are applied to the surface to be coated in separate layers. This finding unlocks a very wide variety of new possibilities for the construction of coatings.

In a first embodiment, the present invention relates to a process for coating surfaces containing the steps of
a) applying a polyisocyanate composition A) to a surface;
b) applying a composition B containing at least one crosslinking catalyst B1 to the same surface; and
c) curing the polyisocyanate composition A by catalytic crosslinking of the polyisocyanate composition A;
with the proviso that the process steps a) and b) are performed in any desired sequence or else simultaneously but prior to process step c).

Sequence of the Process Steps

It is in principle immaterial whether the process comprises applying the polyisocyanate composition A initially and the composition B subsequently or whether the opposite sequence is chosen. It is likewise possible to perform the process steps a) and b) simultaneously. Common to all of the abovementioned sequences of the process steps a) and b) is that mixing of the polyisocyanate composition A and the composition B is occurs only after exiting the apparatus used for application to the surface, preferably only on the surface. The compositions A and B are thus in an unmixed state in the apparatus used for application.

However it has proven advantageous, and is therefore preferable, when the composition B) is applied in the first process step.

According to the invention each of the process steps a) and b) may preferably be repeated at least twice. The relevant process step may be repeated without interposition of the respective other process step. This results for example in a sequence a), a), b) and subsequently c) or b), b), a) and subsequently c).

In a preferred embodiment, the step c) may be performed after at least one layer a) and b) has been applied in any desired sequence. The layer construction may then be continued with a) and b) in any desired sequence, wherein a step c) always completes the construction. This results for example in the sequence a), b), c), a), b), c) or a), b),c), b), a), c) or b), a), c), a), b), c) or b), a), c), b), a), c).

In a preferred embodiment, the process step a) is performed at least twice, wherein the repetition of the process step a) takes place only when the process step b) has been performed. This accordingly results in the sequence a), b), a) with a final step c). Also preferred is a sequence a), b), a), b) and subsequently c).

In a further preferred embodiment, the process step b) is performed at least twice, wherein the repetition of the process step b) takes place only when the process step a) has been performed. This accordingly results in the sequence b), a), b) with a final step c). Also preferred is a sequence b), a), b), a) and subsequently c).

It is preferable when the same polyisocyanate composition A and the same catalyst composition B may be employed when repeating a process step a) or b). This makes it possible for example in printing processes to obtain thick coatings without alterations to the printing machine.

In a further preferred embodiment, the polyisocyanate component A is varied layer by layer and the catalyst composition B is kept constant, thus making it possible to obtain layer-dependent properties so that the obtained coating has a differing construction over its thickness.

In a further preferred embodiment, the catalyst composition B is varied layer by layer and the polyisocyanate composition A is kept constant, thus making it possible to obtain layer-dependent crosslinking rates in step c).

In a further preferred embodiment, both the catalyst composition B is varied layer by layer and the polyisocyanate composition A is varied, thus making it possible to obtain properties and crosslinking rates in step c) that are layer-dependently adapted.

Layer Thickness

The absolute thickness of the layer formed by the polyisocyanate composition A and the ratio of its thickness to the thickness of the layer formed by the composition B is preferably chosen such that in process step c) a curing of the polyisocyanate composition A by catalytic crosslinking as defined in the section “curing” can take place. The formation of the functional groups which bring about crosslinking of the isocyanate groups of the polyisocyanates present in the polyisocyanate composition A can be determined by customary analytical processes, preferably by IR spectroscopy, as described in the working example Alternatively, rheology is also particularly suitable for analysis.

The maximum application weight of the solid constituents of the compositions A and B without accounting for solvents or aqueous constituents of a layer formed by the composition A is preferably ≤250 g/m², more preferably ≤150 g/m², yet more preferably ≤100 g/m² and very particularly preferably ≤90 g/m² per layer application.

The catalyst concentration for the abovementioned application weights is preferably 0.05% by weight to 10% by weight, preferably 0.5% by weight to 5% by weight and most preferably 1% to 4% by weight. This proportion of the catalyst is based on the monoisocyanates and polyisocyanates present in the polyisocyanate composition A.

The maximum application weight as defined above of a layer formed by the composition B is preferably ≤50 g/m², more preferably ≤30 g/m², yet more preferably ≤10 g/m² and very particularly preferably ≤5 g/m² per layer application.

According to the invention it is necessary that at least on a portion of the surface to be coated the polyisocyanate composition A is contacted with the composition B in such a way that in process step c) a catalytic crosslinking of the polyisocyanates present in the polyisocyanate composition A can occur. However, it is not impossible for portions of the surface to be covered by only one of the two compositions or by neither of the two compositions.

Methods of Application

Application of the compositions A and B may be effected by various methods known per se. These are preferably spraying, brushing, dipping, curtain coating, flow coating or application using brushes, rollers, jets or doctor blades. Particular preference is given to printing technologies, in particular screenprinting, valve jet printing, bubble jet printing and piezo printing. The surface to be coated must be sufficiently wetted by the components A and/or B. The calculable wettability of a surface with A and/or B is preferably defined in that the contact angle of the liquid on the surface is not more than 100°, wherein contact angle measurement is preferably performed by means of a tensiometer by the Wilhelmy method.

In a preferred embodiment, both the catalyst and the isocyanate are employed in formulations which ensure sufficient wetting. To this end, those skilled in the art employ additives and formulating assistants known in the paint, adhesive and printing sectors and described in standard works addressing paint, adhesive and printing ink development and application. Information about suitable additives may additionally be found in the literature from firms specialized in this field such as for example in the BYK Additive Guide from BYK-Chemie GmbH.

It is preferable when the surface to be coated is essentially made of a material selected from the group consisting of mineral substances, metal, rigid plastics, flexible plastics, textiles, leather, wood, wood derivatives and paper. Mineral substances are preferably selected from the group consisting of glass, stone, ceramic materials and concrete. In a particularly preferred embodiment, these materials are already in the form of surfaces modified with customary organic or inorganic or hybrid paint, primers, waxes.

In a preferred embodiment of the present invention, the compositions A and B are applied only on parts of the surface to be coated. This makes it possible to generate patterns for example.

It is particularly preferable to initially apply the composition B to the entire surface or parts thereof. The polyisocyanate composition A is subsequently applied only to a portion of the surface covered with the composition B. After the catalytic crosslinking of the polyisocyanate composition A taking place in process step c) the composition B may simply be washed off in the parts not covered by the polyisocyanate composition A to obtain an only partially coated surface.

Such a partially coated surface may also be obtained when the polyisocyanate composition A is applied to the entire surface or parts thereof and subsequently the composition B is applied only to those parts of the surface that are to be coated. After the catalytic crosslinking in process step c) the uncrosslinked polyisocyanate composition A may then be removed from the parts of the surface where no composition B was present.

Index

It is preferable when the molar ratio of the sum of free and reversibly blocked isocyanate groups to the sum of the isocyanate-reactive groups in the reaction mixture that is present on the surface at commencement of the process step c) is at least 3 to 1, preferably at least 5 to 1 and yet more preferably at least 10:1. The “reaction mixture” contains the polyisocyanate composition A, the composition B and all further components that are applied to the surface before commencement of the process step c). “Reversibly blocked” isocyanates are defined hereinbelow in the section “blocked isocyanates”. “Isocyanate-reactive groups” are to be understood as meaning hydroxyl, thiol and amino groups.

Polyisocyanate Composition A

The polyisocyanate composition A is a composition containing at least one polyisocyanate. In one embodiment of the present invention, the polyisocyanate composition A contains not only the at least one polyisocyanate but also at least one component selected from the group consisting of monoisocyanates, solvents, reactive diluents, fillers and additives.

The term “polyisocyanate” as used here is a collective term for compounds containing two or more isocyanate groups (this is understood by the person skilled in the art to mean free isocyanate groups of the general structure —N═C═O) in the molecule. The simplest and most important representatives of these polyisocyanates are the diisocyanates. These have the general structure O═C═N—R—N═C═O where R typically represents aliphatic, alicyclic and/or aromatic radicals. The isocyanate groups of a polyisocyanate may be free or blocked by blocking agents described hereinbelow.

Because of the polyfunctionality (≥2 isocyanate groups), it is possible to use polyisocyanates to produce a multitude of polymers (e.g. polyurethanes, polyureas and polyisocyanurates) and low molecular weight compounds (for example those having uretdione, isocyanurate, allophanate, biuret, iminooxadiazinedione and/or oxadiazinetrione structure).

Where reference is made here to “polyisocyanates” in general terms, this means monomeric and/or oligomeric polyisocyanates alike. For the understanding of many aspects of the invention, however, it is important to distinguish between monomeric diisocyanates and oligomeric polyisocyanates. Where reference is made here to “oligomeric polyisocyanates”, this means polyisocyanates formed from at least two monomeric diisocyanate molecules, i.e. compounds that constitute or contain a reaction product formed from at least two monomeric diisocyanate molecules.

The at least one polyisocyanate present in the polyisocyanate composition A) may be a monomeric polyisocyanate or an oligomeric polyisocyanate. It is likewise possible for the polyisocyanate composition A to contain at least one monomeric polyisocyanate and at least one oligomeric polyisocyanate.

It is preferable when at least one of the monomeric or oligomeric polyisocyanates present in the polyisocyanate composition A has an (average) NCO functionality of 2.0 to 6.0, preferably of 2.3 to 4.5.

Particularly useful results are obtained when the polyisocyanate composition A to be used in accordance with the invention has a content of isocyanate groups of 3.0% to 55.0% by weight. It has been found to be particularly useful when the polyisocyanate composition A) according to the invention has a content of isocyanate groups of 10.0% to 30.0% by weight in each case based on the total weight of all isocyanates present in the polyisocyanate composition A.

Suitable Monomeric Polyisocyanates

Monomeric polyisocyanates for use in the polyisocyanate composition A are monomeric polyisocyanates having a molecular weight in the range from 140 to 400 g/mol which contain aliphatically, cycloaliphatically, araliphatically and/or aromatically bonded isocyanate groups. These polyisocyanates are obtainable in various ways, for example by phosgenation in the liquid or gas phase or by a phosgene-free route, for example by thermal urethane cleavage.

Preferred monomeric isocyanates having aliphatically bonded isocyanate groups are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane and 1,10-diisocyanatodecane.

Preferred monomeric isocyanates having cycloaliphatically bonded isocyanate groups are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexyl methane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

Preferred monomeric isocyanates having araliphatically bonded isocyanate groups are 1,3- and 1,4-bis(isocyanatomethyl)benzene (xyxlylene diisocyanate; XDI), 1,3- and 1,4-bis(1-isocyanato-1-methylethyl)benzene (TMXDI).

Preferred monomeric isocyanates having aromatically bonded isocyanate groups are 2,4- and 2,6-diisocyanatotoluene (TDI), 2,4′- and 4,4′-diisocyanatodiphenylmethane (MDI) and 1,5-diisocyanatonaphthalene.

Further diisocyanates which are likewise suitable may additionally be found, for example, in Justus Liebigs Annalen der Chemie Volume 562 (1949) p. 75-136.

In a preferred embodiment, the polyisocyanate composition A contains at least 40% by weight, preferably 50% by weight, particularly preferably 60% by weight and very particularly preferably 70% by weight of compounds containing at least one isocyanate group with the proviso that the average functionality of the isocyanates present in the polyisocyanate composition A is at least 1.5, more preferably at least 1.7 and yet more preferably at least 2.0.

Production of Oligomeric Polyisocyanates

Oligomeric polyisocyanates employable according to the invention are obtainable from the abovedescribed monomeric polyisocyanates by the procedure of “modification” of monomeric polyisocyanates which is described in the following section. Oligomeric polyisocyanates may be obtained by modification of individual representatives of the abovementioned monomeric polyisocyanates. However, it is also possible to modify mixtures of at least two of the abovementioned monomeric polyisocyanates to obtain oligomeric polyisocyanates constructed from at least two different monomers.

The production of oligomeric polyisocyanates from monomeric diisocyanates is here also referred to as modification of monomeric diisocyanates. This “modification” as used here means the reaction of monomeric diisocyanates to afford oligomeric polyisocyanates having uretdione, isocyanurate, allophanate, biuret, iminooxadiazinedione and/or oxadiazinetrione structure.

Thus for example hexamethylene diisocyanate (HDI) is a “monomeric diisocyanate” since it contains two isocyanate groups and is not a reaction product of at least two polyisocyanate molecules:

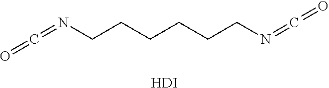

By contrast, reaction products of at least two HDI molecules which still have at least two isocyanate groups are “oligomeric polyisocyanates” in the context of the invention. Proceeding from monomeric HDI representatives of such “oligomeric polyisocyanates” include for example the HDI isocyanurate and the HDI biuret each constructed from three monomeric HDI units:

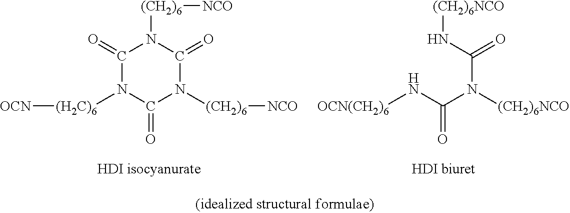

According to the invention the oligomeric polyisocyanates may in particular have uretdione, isocyanurate, allophanate, biuret, iminooxadiazinedione and/or oxadiazinetrione structure. In one embodiment of the invention, the oligomeric polyisocyanates have at least one of the following oligomeric structure types or mixtures thereof:

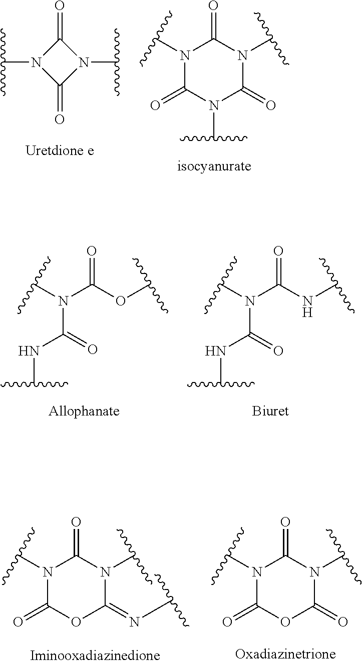

It has been found that, surprisingly, it can be advantageous to use oligomeric polyisocyanates that are a mixture of at least two oligomeric polyisocyanates, wherein the at least two oligomeric polyisocyanates differ in terms of their structure. This structure is preferably selected from the group consisting of uretdione, isocyanurate, allophanate, biuret, iminooxadiazinedione and oxadiazinetrione structure and mixtures thereof. Particularly compared to crosslinking reactions with oligomeric polyisocyanates of just one defined structure, starting mixtures of this kind can lead to an effect on the Tg value, which is advantageous for many applications.

The process according to the invention preferably employs a polyisocyanate composition A) containing at least one oligomeric polyisocyanate having biuret, allophanate, isocyanurate and/or iminooxadiazinedione structure and mixtures thereof.

In another embodiment, an oligomeric polyisocyanate present in the polyisocyanate composition A) is one containing only a single defined oligomeric structure, for example exclusively or very largely an isocyanate structure. However, as a consequence of production the oligomeric polyisocyanates employed according to the invention generally always contain a plurality of different oligomeric structures .

In the context of the present invention oligomeric polyisocyanate is regarded as being constructed from a single defined oligomeric structure when an oligomeric structure selected from uretdione, isocyanurate, allophanate, biuret, iminooxadiazinedione and/or oxadiazinetrione structure is present to an extent of at least 50 mol %, by preference 60 mol %, preferably 70 mol %, particularly preferably 80 mol %, in particular 90 mol %, in each case based on the sum of the present oligomeric structures from the group consisting of uretdione, isocyanurate, allophanate, biuret, iminooxadiazinedione and oxadiazinetrione structure.

In a further embodiment, the process according to the invention employs an oligomeric polyisocyanate of a single defined oligomeric structure, wherein the oligomeric structure is selected from uretdione, isocyanurate, allophanate, biuret, iminooxadiazinedione and/or oxadiazinetrione structure and is present to an extent of at least 50 mol %, by preference 60 mol %, preferably 70 mol %, particularly preferably 80 mol %, in particular 90 mol %, in each case based on the sum of the present oligomeric structures from the group consisting of uretdione, isocyanurate, allophanate, biuret, iminooxadiazinedione and oxadiazinetrione structure in the oligomeric polyisocyanate.

In a further embodiment, the oligomeric polyisocyanates are ones which mainly have an isocyanurate structure and which may contain the abovementioned uretdione, allophanate, biuret, iminooxadiazinedione and/or oxadiazinetrione structure only as byproducts. One embodiment of the invention thus provides for the use of an oligomeric polyisocyanate of a single defined oligomeric structure, wherein the oligomeric structure is an isocyanurate structure and is present to an extent of at least 50 mol %, by preference 60 mol %, preferably 70 mol %, particularly preferably 80 mol %, in particular 90 mol %, in each case based on the sum of the present oligomeric structures from the group consisting of uretdione, isocyanurate, allophanate, biuret, iminooxadiazinedione and oxadiazinetrione structure in the polyisocyanate.

It is likewise possible according to the invention to use oligomeric polyisocyanates which have very largely no isocyanurate structure and contain mainly at least one of the abovementioned uretdione, allophanate, biuret, iminooxadiazinedione and/or oxadiazinetrione structure types. In a particular embodiment of the invention, the employed aoligomeric polyisocyanate consists to an extent of at least 50 mol %, by preference 60 mol %, preferably 70 mol %, particularly preferably 80 mol %, in particular 90 mol %, in each case based on the sum of the present oligomeric structures from the group consisting of uretdione, isocyanurate, allophanate, biuret, iminooxadiazinedione and oxadiazinetrione structure in the polyisocyanate, of oligomeric polyisocyanates having a structure type selected from the group consisting of uretdione, allophanate, biuret, iminooxadiazinedione and/or oxadiazinetrione structure.

A further embodiment of the invention provides for the use of a low-isocyanurate polyisocyanate having, based on the sum of the present oligomeric structures from the group consisting of uretdione, isocyanurate, allophanate, biuret, iminooxadiazinedione and oxadiazinetrione structure in the polyisocyanate not more than 50 mol %, by preference not more than 40 mol %, preferably not more than 30 mol %, particularly preferably not more than 20 mol %, 10 mol % or 5 mol % of isocyanurate structures.

A further embodiment of the invention provides for the use of an oligomeric polyisocyanate of a single defined oligomeric structure type, wherein the oligomeric structure type is selected from the group consisting of uretdione, allophanate, biuret, iminooxadiazinedione and/or oxadiazinetrione structure and this structure type is present to an extent of at least 50 mol %, by preference 60 mol %, preferably 70 mol %, particularly preferably 80 mol %, in particular 90 mol %, based on the sum of the present oligomeric structures from the group consisting of uretdione, isocyanurate, allophanate, biuret, iminooxadiazinedione and oxadiazinetrione structure in the polyisocyanate.

The proportions of uretdione, isocyanurate, allophanate, biuret, iminooxadiazinedione and/or oxadiazinetrione structure in the polyisocyanate composition A) may be determined for example by NMR spectroscopy. Preferably employable here is 13C NMR spectroscopy, preferably in proton-decoupled form, since the oligomeric structures mentioned give characteristic signals.

Production processes for the oligomeric polyisocyanates having uretdione, isocyanurate, allophanate, biuret, iminooxadiazinedione and/or oxadiazinetrione structure for use in the polyisocyanate composition A) according to the invention are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

In an additional or alternative embodiment of the invention, an oligomeric polyisocyanate employable according to the invention is defined in that it contains oligomeric polyisocyanates which irrespective of the nature of the employed modification reaction have been obtained from monomeric diisocyanates while observing an oligomerization level of 5% to 45%, preferably 10% to 40%, particularly preferably 15% to 30%. “Oligomerization level” is understood here to mean the percentage of isocyanate groups originally present in the starting mixture which are consumed during the production process to form uretdione, isocyanurate, allophanate, biuret, iminooxadiazinedione and/or oxadiazinetrione structures.

Adjusting the Viscosity of the Polyisocyanate Composition A

Respectively defined viscosities of the polyisocyanate composition A are particularly suitable for different methods of applying the polyisocyanate composition A to surfaces. Since not every monomeric or oligomeric polyisocyanate has the suitable viscosity as a pure substance at the desired processing temperature the viscosity of the polyisocyanate composition A needs to be adapted for some applications. Oligomeric polyisocyanates in particular have viscosities at room temperature that are too high for some applications.

In a preferred embodiment of the present invention, a polyisocyanate composition A is diluted by addition of a suitable solvent to reduce its viscosity. Suitable solvents are all such solvents which react with isocyanates only slowly, if at all, and which preferably achieve full dissolution thereof and have a boiling point >30° C. and <300° C. Examples include solvents including structural elements selected from ketone, ester, ether, alicyclic rings, heterocyclic rings, aromatics, chlorine and any desired mixtures thereof such as for example ethyl acetate, butyl acetate, methoxypropyl acetate, acetone, methyl ethyl ketone, methyl isobutyl ketone, cyclohexanone, toluene, xylene, Solventnaphtha® 100 and mixtures thereof, Preferred solvents are methyl ethyl ketone, ethyl acetate, butyl acetate and 2-ethylhexyl acetate.

The recited solvents generally ensure good compatibility but the corresponding solutions must be tested for storage stability. The solvents preferably have a water content of not more than 0.05% by weight. They preferably further contain compounds containing reactive groups such as hydroxyl or amino groups in proportions of not more than 0.05% by weight.

In a preferred embodiment of the present invention, the viscosity of a polyisocyanate composition A is adjusted by mixing oligomeric and monomeric polyisocyanates. Since oligomeric isocyanates have a higher viscosity than the monomeric polyisocyanates from which they are constructed suitable mixing of both components makes it possible to establish the desired viscosity of the polyisocyanate composition A. Thus the viscosity of a composition which contains or consists of oligomeric polyisocyanates may be reduced by addition of suitable monomeric polyisocyanates, Conversely, oligomeric polyisocyanate may be added to a composition which contains or consists of monomeric polyisocyanates to increase the viscosity thereof. When the viscosity of a polyisocyanate composition A is adjusted through variation of the proportions of monomeric and oligomeric polyisocyanates this has the advantage over the use of solvents that no volatile organic compounds remain in the coating or require evaporation (drying) before process step c).

In a further preferred embodiment of the present invention, the viscosity of the polyisocyanate composition A is adjusted to the desired value by increasing or reducing the temperature thereof. This process may also be combined with the adjustment of the viscosity by solvent addition or by mixing of monomeric and oligomeric polyisocyanates.

Low-Monomer Polyisocyanate Compositions A

In a preferred embodiment of the present invention, the polyisocyanate composition A is low in monomers (i.e. low in monomeric diisocyanates) and already contains oligomeric polyisocyanates. In one embodiment of the invention, the polyisocyanate composition A consists entirely or to an extent of at least 80%, 85%, 90%, 95%, 98%, 99% or 99.5% by weight, based in each case on the weight of the polyisocyanate composition A, of oligomeric polyisocyanates. This content of oligomeric polyisocyanates is based on the polyisocyanate composition A, meaning that they are not formed, for instance, as intermediate during the process according to the invention, but are already present in the polyisocyanate composition A used as reactant on commencement of the reaction.

“Low in monomers” and “low in monomeric diisocyanates” is here used synonymously in relation to the polyisocyanate composition A.

Particularly useful results are obtained when the polyisocyanate composition A has a proportion of monomeric diisocyanates in the polyisocyanate composition A of not more than 20% by weight, especially not more than 15% by weight or not more than 10% by weight, based in each case on the weight of the polyisocyanate composition A. Preferably, the polyisocyanate composition A has a content of monomeric diisocyanates of not more than 5% by weight, especially not more than 2.0% by weight, more preferably not more than 1.0% by weight, based in each case on the weight of the polyisocyanate composition A. Particularly good results are established when the polymer composition A is essentially free of monomeric diisocyanates. “Essentially free” here means that the content of monomeric diisocyanates is not more than 0.5% by weight, based on the weight of the polyisocyanate composition A.

Low-oligomer polyisocyanate compositions A) are obtainable by employing oligomeric polyisocyanates in whose production the actual modification reaction is in each case followed by at least one further process step for removal of the unconverted excess monomeric diisocyanates. This monomer removal may be carried out particularly usefully by processes known per se, preferably by thin-film distillation under high vacuum or by extraction with suitable solvents that are inert toward isocyanate groups, for example aliphatic or cycloaliphatic hydrocarbons such as pentane, hexane, heptane, cyclopentane or cyclohexane.

In a particularly preferred embodiment of the invention, the polyisocyanate composition A according to the invention is obtained by modifying monomeric diisocyanates with subsequent removal of unconverted monomers.

Use of Blocked Polyisocyanates

In a preferred embodiment of the present invention, at least a portion of the isocyanates present in the polyisocyanate composition A is blocked. According to the invention both monomeric and oligomeric polyisocyanates may be in blocked form. “Blocking” means that the isocyanate groups of a polyisocyanate have been reacted with a further compound, the blocking agent, and the blocked isocyanate groups therefore no longer exhibit the reactivity typical of free isocyanate groups. Only heating of the blocked isocyanate leads to elimination of the blocking agent and restores the reactivity of the isocyanate groups.

It is preferable when at least one compound selected from the group consisting of lactams, oximes, amines and phenols is used as the blocking agent. More preferably, the blocking is effected with at least one lactam and/or oxime. Preferred lactams are selected from the group consisting of δ-valerolactam, laurolactam and ε-caprolactam. A particularly preferred lactam is ε-caprolactam. Preferred oximes are selected from the group consisting of 2-butanone oxime, formaldoxime, acetophenone oxime, diethyl glyoxime, pentanone oxime, hexanone oxime, cyclohexanone oxime and hydroxamic acid. A particularly preferred oxime is 2-butanone oxime. Preferred phenols are selected from the group consisting of phenol, 2,3,5-trimethylphenol, 2,3,6-trimethylphenol, 2,4,6-trimethylphenol, o-cresol, m-cresol, p-cresol, 2-tert-butylphenol and 4-tert-butylphenol. Preferred amines are selected from the group consisting of diisopropylamine, tetramethylpiperidine and N-methyl-tert-butylamine, tert-butylbenzylamine, n-dibutylamine, 3-tert-butylaminomethyl propionate.

It is likewise preferably possible to employ a mixture of two, three or more of the abovementioned compounds as blocking agents or to mix polyisocyanates which have each been blocked with different blocking agents.

In a preferred embodiment of the present invention, the predominant portion of the isocyanate groups present in the polyisocyanate composition A is blocked. Particularly preferably at least 90% by weight, even more preferably at least 95% by weight and most preferably 98% by weight of the isocyanate groups present in the polyisocyanate composition A are blocked. It is very particularly preferable when the polyisocyanate composition A contains no detectable free isocyanate groups. Free isocyanate groups can be determined by means of IR spectroscopy. The NCO band is observed at 2700 cm⁻¹.

Use of Isocyanate-Terminated Prepolymers

A further embodiment of the invention provides for the use of an isocyanate-terminated prepolymer as the oligomeric polyisocyanate. These prepolymers are known to those skilled in the art and are obtainable by reaction of an excess of a suitable monomeric isocyanate, as described hereinabove, with a suitable compound bearing isocyanate-reactive groups.

In the context of the present invention isocyanate-reactive groups are to be understood as meaning amine, amide, urethane, alcohol, thiol, epoxide, carboxylic acid, carboxylic anhydride groups or groups containing Zerewittinoff-active hydrogen. For the definition of Zerewittinoff-active hydrogen reference is made to Römpp Chemie Lexikon, Georg Thieme Verlag Stuttgart. Isocyanate-reactive groups are preferably to be understood as meaning OH, NH and/or SH.

Examples of compounds having isocyanate-reactive groups are monohydric, dihydric and polyhdric alcohols having primary, secondary and tertiary OH groups, analogous thiols, polyols, for example polyether polyols, polyester polyols, polyacrylate polyols, polycarbonate polyols, analogous polythiols, sulfur-containing hydroxyl compounds, amines (for example primary, secondary, aliphatic, cycloaliphatic, aromatic, sterically hindered), polyamines and aspartic esters.

Alcohols may be for example low molecular weight diols (for example 1,2-ethanediol, 1,3- or 1,2-propanediol, 1,4-butanediol), triols (for example glycerol, trimethylolpropane) and tetraols (for example pentaerythritol) but also higher molecular weight polyhydroxyl compounds such as polyether polyols, polyester polyols, polycarbonate polyols, polysiloxane polyols and polybutadiene polyols.

Polyether polyols are obtainable in a manner known per se, by alkoxylation of suitable starter molecules under base catalysis or using double metal cyanide compounds (DMC compounds). Suitable starter molecules for production of polyether polyols are, for example, simple low molecular weight polyols, water, organic polyamines having at least two N—H bonds, or any desired mixtures of such starter molecules. Preferred starter molecules for production of polyether polyols by alkoxylation, especially by the DMC process, are especially simple polyols such as ethylene glycol, propylene 1,3-glycol and butane-1,4-diol, hexane-1,5-diol, neopentyl glycol, 2-ethylhexane-1,3-diol, glycerol, trimethylolpropane, pentaerythritol, and low molecular weight hydroxyl-containing esters of such polyols with dicarboxylic acids of the type specified hereinafter by way of example, or low molecular weight ethoxylation or propoxylation products of such simple polyols, or any desired mixtures of such modified or unmodified alcohols. Alkylene oxides suitable for the alkoxylation are in particular ethylene oxide and/or propylene oxide which can be used in the alkoxylation in any sequence or else in a mixture.

Polyester polyols can be produced in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, succinic acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. It is moreover also possible to polycondense hydroxycarboxylic acid derivatives, for example lactic acid, cinnamic acid or ω-hydroxycaproic acid to afford polyester polyols. However, it is also possible to use polyester polyols of oleochemical origin. Such polyester polyols can be produced, for example, by full ring-opening of epoxidized triglycerides of an at least partly olefinically unsaturated fatty acid-containing fat mixture with one or more alcohols having 1 to 12 carbon atoms and by subsequent partial transesterification of the triglyceride derivatives to alkyl ester polyols having 1 to 12 carbon atoms in the alkyl radical.

The production of suitable polyacrylate polyols is known per se to those skilled in the art. They are obtained by free-radical polymerization of olefinically unsaturated monomers having hydroxyl groups or by free-radical copolymerization of olefinically unsaturated monomers having hydroxyl groups with optionally different olefinically unsaturated monomers, for example ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable hydroxyl-containing, olefinically unsaturated monomers are in particular 2-hydroxyethyl acrylate, 2-hydroxyethyl methacrylate, the hydroxypropyl acrylate isomer mixture obtainable by addition of propylene oxide onto acrylic acid, and the hydroxypropyl methacrylate isomer mixture obtainable by addition of propylene oxide onto methacrylic acid. Suitable free-radical initiators are those from the group of the azo compounds, for example azoisobutyronitrile (AIBN), or from the group of the peroxides, for example di-tert-butyl peroxide.

Amines may be any desired monofunctional or polyfunctional amines, for example methylamine, ethylamine, n-propylamine, isopropylamine, the isomeric butylamines, pentylamines, hexylamines and octylamines, n-dodecylamine, n-tetradecylamine, n-hexadecylamine, n-octadecylamine, cyclohexylamine, the isomeric methylcyclohexylamines, aminomethylcyclohexane, dimethylamine, diethylamine, dipropylamine, diisopropylamine, dibutylamine, diisobutylamine, bis(2-ethylhexyl)amine, N-methyl and N-ethylcyclohexylamine, dicyclohexylamine, hydrazine, ethylenediamine, 1,2-diaminopropane, 1,4-diaminobutane, 2-methylpentamethylenediamine, 1,6-diaminohexane, 2,2,4- and 2,4,4-trimethylhexamethylenediamine, 1,2-diaminocyclohexane, 1-amino-3,3,5-trimethyl-5-aminomethylcyclohexane (isophoronediamine, IPDA), 4,4′-diaminodicyclohexylmethane, pyrrolidine, piperidine, piperazine, (3-aminopropyl)trimethoxysilane, (3-aminopropyl)triethoxysilane and (3-methylamino)propyltrimethoxysilane, aminoalcohols, for example 2-aminoethanol, 2-methylaminoethanol, 2-(dimethylamino)ethanol, 2-(diethylamino)ethanol, 2-(dibutylamino)ethanol, diethanolamine, N-methyldiethanolamine, triethanolamine, 3-amino-1-propanol, 3-dimethylamino-1-propanol, 1-amino-2-propanol, 1-dimethylamino-2-propanol, 1-diethylamino-2-propanol, bis(2-hydroxypropyl)amine, bis(2-hydroxypropyl)methylamine, 2-(hydroxyethyl)bis(2-hydroxypropyl)amine, Tris (2-hydroxypropyl)amine, 4-amino-2-butanol, 2-amino-2-methylpropanol, 2-amino-2-methyl-1,3-propanediol, 2-amino-2-hydroxypropyl-1,3-propanediol and N-(2-hydroxyethyl)piperidine, etheramines, for example 2-methoxyethylamine, 3-methoxypropylamine, 2-(2-dimethylaminoethoxy)ethanol and 1,4-bis-(3-aminopropoxy)butane or aromatic di- and triamines having at least one alkyl substituent having 1 to 3 carbon atoms at the aromatic ring, for example 2,4-tolylenediamine, 2,6-tolylenediamine, 1-methyl-3,5-diethyl-2,4-diaminobenzene, 1,3-diethyl-2,4-diaminobenzol, 1-methyl-3,5-diethyl-2,6-diaminobenzene, 1,3,5-triethyl-2,6-diaminobenzene, 3,5,3′,5′-tetraethyl-4,4′-diaminodiphenylmethane, 3,3′-dimethyl-4,4′-diaminodiphenylmethane, 1-ethyl-2,4-diaminobenzene, 1-ethyl-2,6-diaminobenzene, 2,6-diethylnaphthylene-1,5-diamine, 4,4′-methylenebis(2,6-diisopropylaniline).

It is also possible to employ polyamines, for example the polyaspartic acid derivatives known from EP-B 0 403 921, or else polyamines whose amino groups are in blocked form, for example polyketimines, polyaldimines or oxazolanes. Under the influence of moisture these blocked amino groups are converted into free amino groups and in the case of the oxazolanes also into free hydroxyl groups which can undergo crosslinking with isocyanate groups.

Suitable amino-functional components are in particular polyaspartic esters such as are obtainable for example by the process of EP-B 0 403 92 by reaction of diamines with fumaric or maleic esters.

Preferred amino-functional compounds are polyether polyamines having 2 to 4, preferably 2 to 3 and particularly preferably 2 aliphatically bonded primary amino groups and a number-average molecular weight Mn of 148 to 12200, preferably 148 to 8200, particularly preferably 148 to 4000 and very particularly preferably 148 to 2000 g/mol. Particularly suitable thiols are compounds having at least two thiol groups per molecule.

Preferred polythiols are for example selected from the group consisting of simple alkanethiols, for example methanedithiol, 1,2-ethanedithiol, 1,1-propanedithiol, 1,2-propanedithiol, 1,3-propanedithiol, 2,2-propanedithiol, 1,4-butanedithiol, 2,3-butanedithiol, 1,5-pentanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol or 2-methylcyclohexane-2,3-dithiol, thioether group-containing polythiols, for example 2,4-dimercaptomethyl-1,5-dimercapto-3-thiapentane, 4-mercaptomethyl-1,8-dimercapto-3,6-dithiaoctane, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, 5,6-bis-(mercaptoethylthio)-1,10-dimercapto-3,8-dithiadecane, 4,5-bis(mercaptoethylthio)-1,10-dimercapto-3,8-dithiadecane, tetrakis(mercaptomethyl)methane, 1,1,3,3-tetrakis(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio-1,3-dimercaptopropane, 2,3-bis(mercaptoethylthio)-1-mercaptopropane, 2,2-bis(mercaptomethyl)-1,3-dimercaptopropane, bis(mercaptomethyl) sulfide, bis(mercaptomethyl) disulfide, bis(mercaptoethyl) sulfide, bis(mercaptoethyl) disulfide, bis(mercaptopropyl) sulfide, bis(mercaptopropyl) disulfide, bis-(mercaptomethylthio)methane, tris(mercaptomethylthio)methane, bis(mercaptoethylthio)methane, tris(mercaptoethylthio)methane, bis(mercaptopropylthio)methane, 1,2-bis(mercaptomethylthio)ethane, 1,2-bis(mercaptoethylthio)ethane, 2-(mercaptoethylthio)ethane, 1,3-bis(mercaptomethylthio)propane, 1,3-bis(mercaptopropylthio)propane, 1,2,3-tris(mercaptomethylthio)propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis(mercaptopropylthiomethyl)methane, 2,5-dimercapto-1,4-dithiane, 2,5-bis(mercaptomethyl)-1,4-dithiane and oligomers thereof obtainable as described in JP-A 07118263, 1,5-bis(mercaptopropyl)-1,4-dithiane, 1,5-bis(2-mercaptoethylthiomethyl)-1,4-dithiane, 2-mercaptomethyl-6-mercapto-1,4-dithiacycloheptane, 2,4,6-trimercapto-1,3,5-trithiane, 2,4,6-trimercaptomethyl-1,3,5-trithiane or 2-(3-bis(mercaptomethyl)-2-thiapropyl)-1,3-dithiolane, polyester thiols, for example ethylene glycol bis(2-mercaptoacetate), ethylene glycol bis(3-mercaptopropionate), diethylene glycol 2-mercaptoacetate, diethylene glycol 3-mercaptopropionate, 2,3-dimercapto-1-propanol 3-mercaptopropionate, 3-mercapto-1,2-propanediol bis(2-mercaptoacetate), 3-mercapto-1,2-propanediol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), glycerol tris(2-mercaptoacetate), glycerol tris(3-mercaptopropionate), 1,4-cyclohexanediol bis(2-mercaptoacetate), 1,4-cyclohexanediol bis(3-mercaptopropionate), hydroxymethyl sulfide bis(2-mercaptoacetate), hydroxymethyl sulfide bis(3-mercaptopropionate), hydroxyethyl sulfide 2-mercaptoacetate, hydroxyethyl sulfide 3-mercaptopropionate, hydroxymethyl disulfide 2-mercaptoacetate, hydroxymethyl disulfide 3-mercaptopropionate, 2-mercaptoethyl ester thioglycolate or bis(2-mercaptoethyl ester) thiodipropionate and aromatic thio compounds, for example 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, 2,5-toluenedithiol, 3,4-toluenedithiol, 1,4-naphthalenedithiol, 1,5-naphthalenedithiol, 2,6-naphthalenedithiol, 2,7-naphthalenedithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl or 4,4′-dimercaptobiphenyl. Such polyols may be employed individually or else in the form of any desired mixtures with one another.

Sulfur-containing hydroxyl compounds are likewise suitable. Such compounds preferably contain at least one sulfur atom in the form of thio groups, thioether groups, thioesterurethane groups, esterthiourethane groups and/or polythioesterthiourethane groups and at least one OH group.

Preferred sulfur-containing hydroxyl groups may be selected from the group consisting of simple mercapto alcohols, for example 2-mercaptoethanol, 3-mercaptopropanol, 1,3-dimercapto-2-propanol, 2,3-dimercaptopropanol or dithioerythritol, thioether-containing alcohols, for example di(2-hydroxyethyl)sulfide, 1,2-bis(2-hydroxyethylmercapto)ethane, bis(2-hydroxyethyl)disulfide or 1,4-dithiane-2,5-diol and sulfur-containing diols having polyesterurethane, polythioesterurethane, polyesterthiourethane or polythioesterthiourethane structure of the type recited in EP-A 1 640 394. Such sulfur-containing hydroxyl compounds may be used individually or else in the form of any desired mixtures with one another.

Particularly preferred sulfur-containing compounds are polyether and polyester thiols of the recited type. Very particularly preferred compounds may be selected from the group consisting of 4-mercaptomethyl-1,8-dimercapto-3,6-dithiaoctane, 1,1,3,3-tetrakis(mercaptomethylthio)propane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, trimethylolpropanetris(2-mercaptoacetate), trimethylolpropanetris(3-mercaptopropionate), Pentaerythritoltetrakis(2-mercaptoacetate) and pentaerythritoltetrakis(3-mercaptopropionate).

Likewise suitable as compounds having isocyanate-reactive groups are carboxylic acids, carboxylic anhydrides and epoxides.

It is likewise possible for the isocyanate-reactive component to comprise mixtures of different compounds having isocyanate-reactive groups.

The polyisocyanate component A may in principle contain any desired mixture of different polyisocyanates. These may be the mixtures of oligomeric and monomeric polyisocyanates described hereinabove. Mixtures of different isocyanate-terminated prepolymers may also be concerned. Free combination of all suitable polyisocyanates makes it possible to adjust the properties of the coating as desired.

It is likewise in accordance with the invention to mix isocyanate-terminated prepolymers with monomeric or oligomeric polyisocyanates. This embodiment of the invention has the advantage that monomeric and/or oligomeric polyisocyanates may be used to reduce the viscosity of an isocyanate-terminated prepolymer. Since the monomeric/oligomeric polyisocyanates may be crosslinked with one another and with the isocyanate-terminated prepolymer by their isocyanate groups these are bound in the coating at the end of the process step c). They therefore act as reactive diluents.

Ratio of Aromatic Polyisocyanates to Aliphatic Polyisocyanates

Preferably at least 50% by weight, more preferably at least 65% by weight, yet more preferably at least 80% by weight and most preferably at least 90% by weight of the monomeric and oligomeric polyisocyanates present in the polyisocyanate composition A contain isocyanates having aliphatically bonded isocyanate groups. It is very particularly preferable when the polyisocyanate composition A contains as polyisocyanates only those having aliphatically bonded isocyanate groups.

Crosslinking Catalyst B1

Suitable catalysts B1 for the process according to the invention are in principle any compounds which accelerate the crosslinking of isocyanate groups. According to the invention this crosslinking is effected by the formation of at least one structure selected from the group consisting of uretdione, iminoxadiazinedione, allophanate, urea and isocyanate groups. Which of these structures is predominantly or exclusively formed depends on the employed catalyst and the reaction conditions.

In a preferred embodiment the “catalytic crosslinking” brought about by the catalyst B1 has the result that predominantly cyclotrimerizations of at least 30%, preferably at least 50%, particularly preferably at least 60%, in particular at least 70% and very particularly preferably at least 80% of the isocyanate groups present in the polyisocyanate composition A are converted into isocyanurate structural units. However, side reactions, in particular those forming uretdione, allophanate and/or iminooxadiazinedione structures, do typically occur and can even be specifically utilized to advantageously influence the Tg value of the obtained polyisocyanurate plastic for example.

Suitable catalysts B1 for the process according to the invention are, for example, simple tertiary amines, for example triethylamine, tributylamine, N,N-dimethylaniline, N-ethylpiperidine or N,N′-dimethylpiperazine. Suitable catalysts also include the tertiary hydroxyalkylamines described in GB 2 221 465, for example triethanolamine, N-methyldiethanolamine, dimethylethanolamine, N-isopropyldiethanolamine and 1-(2-hydroxyethyl)pyrrolidine or the catalyst systems known from GB 2 222 161 that consist of mixtures of tertiary bicyclic amines, for example DBU, with simple aliphatic alcohols of low molecular weight.

Likewise suitable as crosslinking catalysts 81 for the process according to the invention are a multitude of different metal compounds. Examples of suitable compounds include the octoates and naphthenates of manganese, iron, cobalt, nickel, copper, zinc, zirconium, cerium or lead or mixtures thereof with acetates of lithium, sodium, potassium, calcium or barium that are described as catalysts in DE-A 3 240 613, the sodium and potassium salts of linear or branched alkanecarboxylic acids having up to 10 carbon atoms that are known from DE-A 3 219 608, for example of propionic acid, butyric acid, valeric acid, caproic acid, heptanoic acid, caprylic acid, pelargonic acid, capric acid and undecylenoic acid, the alkali metal or alkaline earth metal salts of aliphatic, cycloaliphatic or aromatic mono- and polycarboxylic acids having 2 to 20 carbon atoms that are known from EP-A 0 100 129, for example sodium or potassium benzoate, the alkali metal phenoxides known from GB-A 1 391 066 and GB-A 1 386 399, for example sodium or potassium phenoxide, the alkali metal and alkaline earth metal oxides, hydroxides, carbonates, alkoxides and phenoxides known from GB 809 809, alkali metal salts of enolizable compounds and metal salts of weak aliphatic or cycloaliphatic carboxylic acids, for example sodium methoxide, sodium acetate, potassium acetate, sodium acetoacetate, lead 2-ethylhexanoate and lead naphthenate, the basic alkali metal compounds complexed with crown ethers or polyether alcohols that are known from EP-A 0 056 158 and EP-A 0 056 159, for example complexed sodium or potassium carboxylates, the pyrrolidinone-potassium salt known from EP-A 0 033 581, the mono- or polynuclear complex of titanium, zirconium and/or hafnium known from application EP 13196508.9, for example zirconium tetra-n-butoxide, zirconium tetra-2-ethylhexanoate and zirconium tetra-2-ethylhexoxide, and tin compounds of the type described in European Polymer Journal, vol. 16, 147-148 (1979), for example dibutyltin dichloride, diphenyltin dichloride, triphenylstannanol, tributyltin acetate, tributyltin oxide, tin octoate, dibutyl(dimethoxy)stannane and tributyltin imidazolate.

Further crosslinking catalysts B1 suitable for the process according to the invention are, for example, the quaternary ammonium hydroxides known from DE-A 1 667 309, EP-A 0 013 880 and EP-A 0 047 452, for example tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2]octane hydroxide (monoadduct of ethylene oxide and water with 1,4-diazabicyclo[2.2.2]octane), the quaternary hydroxyalkylammonium hydroxides known from EP-A 37 65 or EP-A 10 589, for example N,N,N-trimethyl-N-(2-hydroxyethyl)ammonium hydroxide, the trialkylhydroxylalkylammonium carboxylates that are known from DE-A 2631733, EP-A 0 671 426, EP-A 1 599 526 and U.S. Pat. No. 4,789,705, for example N,N,N-trimethyl-N-2-hydroxypropylammonium p-tert-butylbenzoate and N,N,N-trimethyl-N-2-hydroxypropylammonium 2-ethylhexanoate, the quaternary benzylammonium carboxylates known from EP-A 1 229 016, such as N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium 2-ethylhexanoate or N,N,N-tributyl-N-(4-methoxybenzyl)ammonium pivalate, the tetrasubstituted ammonium α-hydroxycarboxylates known from WO 2005/087828, for example tetramethylammonium lactate, the quaternary ammonium or phosphonium fluorides known from EP-A 0 339 396, EP-A 0 379 914 and EP-A 0 443 167, for example N-methyl-N,N,N-trialkylammonium fluorides with C8-C10-alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride, the quaternary ammonium and phosphonium polyfluorides known from EP-A 0 798 299, EP-A 0 896 009 and EP-A 0 962 455, for example benzyltrimethylammonium hydrogen polyfluoride, the tetraalkylammonium alkylcarbonates which are known from EP-A 0 668 271 and are obtainable by reaction of tertiary amines with dialkyl carbonates, or betaine-structured quaternary ammonioalkyl carbonates, the quaternary ammonium hydrogencarbonates known from WO 1999/023128, such as choline bicarbonate, the quaternary ammonium salts which are known from EP 0 102 482 and are obtainable from tertiary amines and alkylating esters of phosphorus acids, examples of such salts being reaction products of triethylamine, DABCO or N-methylmorpholine with dimethyl methanephosphonate, or the tetrasubstituted ammonium salts of lactams that are known from WO 2013/167404, for example trioctylammonium caprolactamate or dodecyltrimethylammonium caprolactamate.

Further crosslinking catalysts suitable for the process of the invention can be found, for example, in .I. H. Saunders and K. C. Frisch, Polyurethanes Chemistry and Technology, p. 94 ff. (1962) and the literature cited therein.

The catalysts B1 may be employed in the process according to the invention either individually or in the form of any desired mixtures with one another.

In a preferred embodiment of the present invention at least one crosslinking catalyst B1 is an alkaline salt selected from the group consisting of alkoxides, amides, phenoxides, carboxylates, carbonates, hydrogencarbonates, hydroxides, cyanides, isocyanides, thiocyanides, sulphinates, sulphites, phosphinates, phosphonates, phosphates or fluorides. The counterion is preferably selected from the group consisting of metal ions, ammonium compounds, phosphonium compounds and sulphur compounds.

Particular preference is given to alkoxides and carboxylates having metal or ammonium ions as the counterion. Suitable carboxylates are the anions of all aliphatic or cycloaliphatic carboxylic acids, preferably those with mono- or polycarboxylic acids having 1 to 20 carbon atoms. Suitable metal ions are derived from alkali metals or alkaline earth metals, manganese, iron, cobalt, nickel, copper, zinc, zirconium, cerium, tin, titanium, hafnium or lead. Preferred alkali metals are lithium, sodium and potassium, particularly preferably sodium and potassium. Preferred alkaline earth metals are magnesium, calcium, strontium and barium.

It is very particularly preferable to employ potassium acetate as the crosslinking catalyst B1 alone or in combination with other crosslinking catalysts B1.

When the process step c) is to be performed at room temperature it is particularly preferable to use potassium acetate in combination with tin octoate and/or tributyltin as crosslinking catalysts B1. In this embodiment the use of polyethers B2 is particularly preferred.

When blocked isocyanates as defined hereinabove are present in the polyisocyanate composition A it is preferable to use the known sodium and potassium salts of linear or branched alkane carboxylic acids having up to 14 carbon atoms, for example butyric acid, valeric acid, caproic acid, 2-ethylhexanoic acid, heptanoic acid, caprylic acid, pelargonic acid and higher homologues as the crosslinking catalyst B1. In this case the use of potassium 2-ethylhexanoate as crosslinking catalyst B1 is very particularly preferred.

In a particular embodiment, in particular in connection with thermally activated blocked isocyanates, it is preferable to use highly reactive catalysts preferably based on alkali metal and alkaline earth metal alkoxides.

Polyether B2

In a preferred embodiment of the present invention the composition B contains a polyether B2 in addition to the at least one crosslinking catalyst B1. This is preferred in particular when the catalyst contains metal ions. Preferred polyethers B2 are selected from the group consisting of crown ethers, diethylene glycol, polyethylene glycols and polypropylene glycols. In the process according to the invention it has been found to be particularly useful to employ a polyethylene glycol or a crown ether, particularly preferably 18-crown-6 or 15-crown-5, as polyether B2. The composition B preferably contains a polyethylene glycol having a number-average molecular weight of 100 to 1000 g/mol, preferably 300 g/mol to 500 g/mol and in particular 350 g/mol to 450 g/mol. It is very particularly preferable when the composition B contains the combination of basic salts of alkali metals or alkaline earth metals as defined above with a polyether.

It is especially preferable for the composition B to contain potassium acetate and 18-crown-6.

Catalyst Solvent B3

Suitable catalyst solvents B3 are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxyprop-2-yl acetate, 3-methoxy-n-butyl acetate, propylene glycol diacetate, acetone, methyl ethyl ketone, methyl isobutyl ketone, cyclohexanone, lactones such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

However, it is also possible according to the invention to use catalyst solvents B3 bearing isocyanate-reactive groups. Examples of such solvents are mono- or polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetra hydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethylallyl alcohol or oleyl alcohol; araliphatic alcohols, for example benzyl alcohol; N-monosubstituted amides, for example N-methylformamide, N-methylacetamide, cyanoacetamide or 2-pyrrolidinone, or any desired mixtures of such solvents.

Curing

The curing of the polyisocyanate composition A proceeds via the formation of at least one structure selected from the group consisting of uretdione, iminoxadiazinedione, oxadiazinetrione, allophanate, urea and isocyanurate groups between the isocyanate groups of the polyisocyanates present. This crosslinks the polyisocyanates present in the polyisocyanate composition A with one another to form a solid layer. In the case of formation of allophanate groups the catalytic crosslinking is effected by reaction of an isocyanate group with a urethane group present in an oligomeric polyisocyanate. In the case of formation of urea groups the crosslinking is effected by reaction of an isocyanate group with an amino group present in one of the isocyanates of the polyisocyanate composition A. Said amino group is preferably formed during the crosslinking reaction by the reaction of an isocyanate group with water (for example atmospheric humidity) and subsequent elimination of carbon dioxide.

If hydroxyl groups are present in the polyisocyanate composition A or the composition B the formation of urethane groups is also possible.

This curing is carried out at a temperature sufficiently high for the at least one catalyst B1 present in the composition B to bring about the above-described crosslinking reactions. The optimal reaction temperature is preferably from 10° C. to 300° C., more preferably from 20° C. to 250° C. and particularly preferably 20° C. to 200° C. The reaction temperature may be kept constant in the recited range during the entire curing process to afford the polyisocyanurate or else may be increased linearly or stepwise for example over several hours to a temperature greater than 80° C., preferably greater than 100° C. and more preferably to greater than 130° C. Where reference is made here to “reaction temperature”, this means the ambient temperature at the surface.

In a preferred embodiment of the present invention, the curing in process step c) is performed in two stages. In a process step c1) the reaction temperature is preferably in the range from 50° C. to 300° C., more preferably 60° C. to 250° C. and particularly preferably 80° C. to 200° C. In a subsequent process step c2) the curing is carried out at reduced temperature, preferably in the range from 5° C. to 79° C., more preferably from 10° C. to 59° C. and particularly preferably from 15° C. to 40° C. It is preferable when this second step is performed without active heating of the material. It is further preferred when the material is stored unsealed at normal atmospheric humidity. In this context “normal atmospheric humidity” preferably refers to an absolute atmospheric humidity between 1 g/m³ and 15 g/m³. It is further preferred when process step c1) is performed in a shorter time than process step c2).

One embodiment in which the curing is performed in two stages has the great advantage that the curing in process step c1) requires only a short time and needs to be performed only until the coated surface is no longer tacky and the properties make it possible to subject the workpiece to further processing or to its intended use. The process step c2) is then carried out without additional measures during the further processing, storage or use of the coated workpiece under normal ambient conditions. The formation of the amino groups required for the formation of urea groups may be effected by the action of atmospheric humidity on isocyanate groups.

The process step c1) is preferably performed until the coated surface is no longer tacky. It is preferably the case when at least 30 mol %, more preferably at least 50 vol %, yet more preferably at least 60 mol %, very particularly preferably 70 mol % and most preferably at least 80 mol % of the isocyanate groups originally present in the polyisocyanate composition A have been consumed. It is in particular preferable when at least 90 mol % of the originally present isocyanate groups have been consumed at the end of the process step c1).

When using blocked isocyanates it is necessary to achieve a temperature which brings about elimination of the chosen blocking agent at commencement of the process step c). This temperature is at least 120° C., more preferably at least 150° C. and most preferably at least 180° C. These temperatures are held until the blocking agent has been eliminated from at least 50 vol %, more preferably at least 70 vol %, yet more preferably at least 90 vol % and most preferably at least 95 mol % of the originally blocked isocyanate groups.

Depending on the chosen crosslinking catalyst B1 and the chosen reaction temperature the crosslinking reaction is very largely complete as defined hereinbelow as a result of “complete curing” of the polyisocyanate composition A after a period of from a few seconds up to several hours. In practice it has been found that at reaction temperatures of greater than 80° C. the crosslinking reaction is typically very largely complete in less than 12 h. In a preferred embodiment of the invention, at a reaction temperature of greater than 80° C. the crosslinking reaction is complete within less than 12 h, particularly preferably less than 5 h, very particularly preferably less than 1 h. The progress of the reaction may be monitored by spectroscopic methods, for example by IR spectroscopy via the intensity of the isocyanate band at about 2270 cm⁻¹. When the process step c) is completely or partially carried out at temperatures below 80° C. the complete curing of the polyisocyanate composition A may also require several days, preferably up to 14 days.

The coatings obtainable by the process according to the invention are preferably highly converted polymers, i.e. polymers that are “completely cured” at the end of the process step c). In the context of the present invention a polyisocyanate composition A is regarded as “completely cured” in the context of the present invention when at least 70 mol %, preferably at least 80 mol %, particularly preferably at least 90 mol %, of the free isocyanate groups originally present therein have reacted. In other words preferably not more than 30 mol %, more preferably not more than 20 mol % and particularly preferably not more than 10 mol % of the isocyanate groups originally present in the polyisocyanate composition A are still present in the cured coating.

It is in particular preferable when the cured coating contains only 5 mol % of the free isocyanate groups originally present therein. Conversely this entails a conversion of at least 95 mol % of the original lay present free isocyanate groups.

The percentage of isocyanate groups still present can be determined by comparison of the content of isocyanate groups in % by weight in the original polyisocyanate composition A with the content of isocyanate groups in % by weight in the reaction product, for example by the aforementioned comparison of the intensity of the isocyanate band at about 2270 cm⁻¹ by means of IR spectroscopy. As an internal reference, CH₂ and CH₃ vibrations are used as a reference parameter for the NCO band and related thereto. This is done both for the reference measurement prior to crosslinking and for the measurement after crosslinking.

Some of the abovedescribed catalysts B1 also allow curing of the polyisocyanate composition A at room temperature, wherein room temperature here describes a temperature range between 10° C. and 47° C. In this case the process step c) must in some cases be performed over several days.

When the process according to the invention is performed with the phosphine catalysts described hereinabove and at room temperature not only isocyanurate groups but also uretdione groups are formed in the course of the catalytic crosslinking. It is preferable when in this embodiment at least 30 mol %, more preferably at least 40 mol % and most preferably at least 60 mol % of the isocyanate groups originally present in the polyisocyanate composition A are converted into uretdione and isocyanurate groups.

A further embodiment of the present invention relates to surfaces coated by the process according to the invention.

Advantages

When the catalyst and the isocyanate component are mixed before application, onset of the reaction already occurs with the mixing. This has the result that the mixed material can only be utilized for a short time (pot life). If for example the viscosity has increased too severely as a result of the reaction, the material can no longer be employed.

Separate application of the catalyst and the isocyanate component has the decisive advantage that onset of the reaction occurs only after application onto the substrate. There is therefore no increase in viscosity as a consequence of reaction provided that the components are properly stored. Proper storage of isocyanate-containing compounds encompasses safety measures well known to those skilled in the art such as exclusion of water, storage in water-tight and water vapor-tight vessels at temperatures <50° C.

The working examples which follow serve merely to illustrate the invention. They are not intended to restrict the scope of protection of the claims.

### EXAMPLES

Methods and Employed Materials:

NCO Number Determination by FT-IR Spectrometer Fitted with an ATR Unit

Determination of the NCO number employed an FT-IR spectrometer (Tensor II) from Bruker fitted with a platinum ATR unit.

In all experiments the components were applied to a glass plate and subsequently subjected to the temperature program. To effect measurement either the liquid or the film was lifted from the glass plate and subsequently contacted on the platinum ATR unit. To this end the films were placed with their front side on the 2×2 mm sample window of the ATR unit and pressed down with a tamper. For liquid samples the window was wetted with a droplet.

Depending on the wavenumber the IR radiation penetrates 3-4 μm into the sample during the measurement. An absorption spectrum was then obtained from the sample.

In order to compensate nonuniform contacting of the samples of different hardness, both a baseline correction and a normalization using the evaluation program OPUS were performed on all spectra.

The normalization was based on the CH₂ and CH₃ bands. To this end, the wavenumber range of 2600 to 3200 was chosen. The program determined the highest peak in this region and scaled the entire spectrum such that this maximum peak has a value of 2.

To determine the NCO number the peak in the wave number range from 2170 to 2380 (NCO-Peak) was integrated.

Determining Conversion of NCO Groups

To determine the conversion of the NCO groups a reference value is initially required. To this end, the isocyanate component was initially measured by FTIR without any thermal treatment and without reaction. For Desmodur® N3600 an NCO number of 878 was obtained (see example 1). The percentage conversion was obtained by dividing the NCO number determined after an experiment by 878, subtracting the obtained value from 1 and subsequently multiplying the result by 100. Thus for example an NCO number of 830 was measured in example 2. This then resulted in:

830/878=0.9453

1−0.9453=0.05467

0.05467*100%=5.467

The rounded conversion level in example 2 is thus 5.5%.

Droplet Weight Determination

The majority of applied materials was applied using a digital printer (Dimatix DMP 2831, printing head DMC-11610 (16 nozzles and a nominal droplet size of 10 pp). Since the actual droplet volume and thus the droplet weight is dependent on many parameters this was determined before application. To this end, 3 million droplets were printed into a previously weighed plastic dish before immediately determining the net weight. The following droplet weights were determined for the examples.

Isocyanate component: 6.81289*10⁻⁹ g/droplet

Catalyst mixture: 6.31944*10⁻⁹ g/droplet

Desmodur® N3600

Solvent-free polyisocyanurate based on HDI having an NCO content of 23.0±0.5% (according to M105-ISO 11909) and a viscosity at 23° C. of 1.200±300 mPa·s (according to M014-ISO 3219/A.3.)

Butyl Acetate (BA)

Butyl acetate 98/100 from Azelis, Antwerp;

BYK® 141 and BYK® 331

Additives from BYK Additives & Instruments, Wesel

BYK 141 is a silicon-containing defoamer for solvent-containing and solvent-free polyurethane-based paint systems and cold-curing plastics applications.

BYK 331 is a silicone-containing surface additive for solvent-containing, solvent-free and aqueous paints and printing inks for intermediate reduction of surface tension and intermediate increasing of surface smoothness.

Isocyanate Ink

70 parts by weight of Desmodur®, 30 parts by weight of butyl acetate, 0.4 parts by weight of BYK® 141 and 0.03 parts by weight of BYK® 331

Potassium Acetate

Potassium acetate having a purity of ≥99% was obtained from Acros

18-Crown-6

18-Crown-6 having a purity of ≥99% from Sigma Aldrich.

Diethylene Glycol

Diethylene glycol having a purity of 99% from Sigma Aldrich.

Catalyst Mixture

177 parts by weight of potassium acetate, 475 parts by weight of 18-Crown-6 and 3115 parts by weight of diethylene glycol. Potassium acetate is initially charged before initially the crown ether and subsequently the diethylene glycol are added. The dissolving time was 2 days wherein the mixture was in each case manually shaken once per hour during the eight hour working time and left to stand overnight

The raw materials were used without further purification or pretreatment unless otherwise stated.

Procedure:

The catalyst and the isocyanate ink were consecutively applied by means of a digital printer (Dimatix DMP 2831, printing head DMC-11610 (16 jets and a nominal droplet size of 10 pl)) to a previously washed and dried glass sheet such that the layers were disposed one on top of the other. The ratio of the two components was adjusted by setting different DPI values. After application the coated glass sheets were flashed off for 10 minutes and subsequently cured at 180° C. for 10 minutes in a recirculating drying cabinet. After curing an ATR-FT-IR instrument was used to determine the NCO number at the surface of the coating.

As a comparison 50 μm of a premixed system having a comparable mixing ratio was blade coated onto a glass sheet. After application the coated glass sheets were flashed off for 10 minutes and subsequently cured at 180° C. for 10 minutes in a recirculating drying cabinet before an ATR-FT-IR instrument was used to determine the NCO number at the surface of the coating.

In the investigation of the different application weights the same number of catalyst layers as subsequent isocyanate ink layers was always printed.

In further comparative examples only the isocyanate component was applied:
after application of the isocyanate component the sample was flashed off for 10 minutes, then heat treated at 180° C. for 10 minutes in the recirculating drying cabinet before the NCO number at the surface was determined
after application of the isocyanate ink the sample was flashed off for 10 minutes, then heat treated at 180° C. for 10 minutes in the recirculating drying cabinet before the NCO number at the surface was determined

Results:

| | | | NCO number | |
|---|---|---|---|---|
| | | | at the | Converted NCO |
| Example | Application | Description/remarks | surface/result | groups [%] |
| 1 | Desmodur ® N3600 without | Determination of baseline | 878 | 0 |
| (comparative) | heating | value for pure | | |
| | | polyisocyanate | | |
| 2 | Desmodur ® N3600, 10′ flash | Determination of baseline | 830 | 5.5 |
| (comparative) | off, 10′ at 180° C. in | value for pure | | |
| | recirculating drying cabinet | polyisocyanate | | |
| 3 | Desmodur ® N3600 (70% in | Determination of baseline | 800 | 8.9 |
| (comparative) | butyl acetate), 10′ flash off, | value for 70% | | |
| | 10′ at 180° C. in recirculating | polyisocyanate in butyl | | |
| | drying cabinet | acetate with subsequent | | |
| | | thermal treatment | | |
| 4 | Blade coating of 50 μm of a | Comparative example for a | 7 | 99.2 |
| (comparative) | Desmodur ® N3600 | premixed system applied to | | |
| | (pure)/catalyst mixture | a glass sheet by blade | | |
| | (mixing ratio 33/1), 10′ flash | coating. The polyisocyanate | | |
| | off, 10′ at 180° C. in | was employed in undiluted | | |
| | recirculating drying cabinet | form | | |
| 5 | Blade coating of 50 μm of a | Comparative example for a | 47 | 94.6 |
| (comparative) | mixture of Desmodur ® N3600 | premixed system applied to | | |
| | (70% in butyl acetate) and | a glass sheet by blade | | |
| | catalyst (mixing ratio 33/1, | coating. The polyisocyanate | | |
| | neglecting solvent), 10′ flash | was employed as 70% in | | |
| | off, 10′ at 180° C. in | butyl acetate | | |
| | recirculating drying cabinet | | | |
| 6 | Layer 1: cat (211 DPI) | Calculated application | 17 | 98.1 |
| | Layer 2: isocyanate ink | weight: Isocyanate ink: | | |
| | (1400 DPI) | 20.7 g/m² (wet) | | |
| | 10′ flash off, 10′ curing at | 14.5 g/m² (solid) | | |
| | 180° C. in recirculating drying | Catalyst ink: | | |
| | cabinet | 0.44 g/m² | | |
| 7 | Layer 1: isocyanate ink | Calculated application | 147 | 83.3 |
| | (1400 DPI) | weight: Isocyanate ink: | | |
| | Layer 2: cat (211 DPI) | 20.7 g/m² (wet) | | |
| | 10′ flash off, 10′ curing at | 14.5 g/m² (solid) | | |
| | 180° C. in recirculating drying | Catalyst ink: | | |
| | cabinet | 0.44 g/m² | | |
| 8 | Layer 1: cat (149 DPI) | Calculated application | 26 | 97.0 |
| | Layer 2: isocyanate ink | weight: Isocyanate ink: | | |
| | (1400 DPI) | 20.7 g/m² (wet) | | |
| | Layer 3: cat (149 DPI) | 14.5 g/m² (solid) | | |
| | 10′ flash off, 10′ curing at | Catalyst ink: | | |
| | 180° C. in recirculating drying | 2 * 0.22 g/m² | | |
| | cabinet | | | |
| 9 | Layer 1: isocyanate ink | Calculated application | 236 | 73.1 |
| | (990 DPI) | weight: Isocyanate ink: | | |
| | Layer 2: cat (211 DPI) | 2 * 10.3 g/m² (wet) | | |
| | Layer 3: isocyanate ink | 2 * 7.2 g/m² (solid) | | |
| | (990 DPI) | Catalyst ink: | | |
| | 10′ flash off, 10′ curing at | 0.44 g/m² | | |
| | 180° C. in recirculating drying | | | |
| | cabinet | | | |
| 10 | Layer 1: 2x cat (211 DPI) | Calculated application | 11 | 98.7 |
| | Layer 2: 2x isocyanate ink | weight: Isocyanate ink: | | |
| | (1400 DPI) | 41.4 g/m² (wet) | | |
| | 10′ flash off, 10′ curing at | 29.0 g/m² (solid) | | |
| | 180° C. in recirculating drying | Catalyst ink: | | |
| | cabinet | 0.87 g/m² | | |
| 11 | Layer 1: 3x cat (211 DPI) | Calculated application | 24 | 97.3 |
| | Layer 2: 3x isocyanate ink | weight: Isocyanate ink: | | |
| | (1400 DPI) | 62.1 g/m² (wet) | | |
| | 10′ flash off, 10′ curing at | 43.5 g/m² (solid) | | |
| | 180° C. in recirculating drying | Catalyst ink: | | |
| | cabinet | 1.31 g/m² | | |
| 12 | Layer 1: 4x cat (211 DPI) | Calculated application | 61 | 93.1 |
| | Layer 2: 4x isocyanate ink | weight: Isocyanate ink: | | |
| | (1400 DPI) | 82.8 g/m² (wet) | | |
| | 10′ flash off, 10′ curing at | 58.0 g/m² (solid) | | |
| | 180° C. in recirculating drying | Catalyst ink: | | |
| | cabinet | 1.74 g/m² | | |
| 13 | Layer 1: 5x cat (211 DPI) | Calculated application | 36 | 95.9 |
| | Layer 2: 5x isocyanate ink | weight: Isocyanate ink: | | |
| | (1400 DPI) | 103.5 g/m² (wet) | | |
| | 10′ flash off, 10′ curing at | 72.4 g/m² (solid) | | |
| | 180° C. in recirculating drying | Catalyst ink: | | |
| | cabinet | 2.18 g/m² | | |
| 14 | Layer 1: 6x cat (211 DPI) | Calculated application | 67 | 92.4 |
| | Layer 2: 6x isocyanate ink | weight: Isocyanate ink: | | |
| | (1400 DPI) | 124.2 g/m² (wet) | | |
| | 10′ flash off, 10′ curing at | 86.9 g/m² (solid) | | |
| | 180° C. in recirculating drying | Catalyst ink: | | |
| | cabinet | 2.62 g/m² | | |
| 15 | Layer 1: 7x cat (211 DPI) | Calculated application | 289 | 67.1 |
| | Layer 2: 7x isocyanate ink | weight: Isocyanate ink: | | |
| | (1400 DPI) | 144.9 g/m² (wet) | | |
| | 10′ flash off, 10′ curing at | 101.4 g/m² (solid) | | |
| | 180° C. in recirculating drying | Catalyst ink: | | |
| | cabinet | 3.05 g/m² | | |
| 16 | Layer 1: cat (211 DPI), | Calculated application | A clear image | |
| | full surface | weight: Isocyanate ink: | is obtained | |
| | Layer 2: isocyanate ink | 20.7 g/m² (wet) | | |
| | (1400 DPI), image | 14.5 g/m² (solid) | | |
| | 10′ flash off, 10′ curing at | Catalyst ink: | | |
| | 180° C. in recirculating drying | 0.44 g/m² | | |
| | cabinet, wash off excess | | | |
| | catalyst with butyl acetate | | | |
| 17 | Layer 1: isocyanate ink | Calculated application | A clear image | |
| | (1400 DPI), full | weight: Isocyanate ink: | is obtained | |
| | surface | 20.7 g/m² (wet) | | |
| | Layer 2: cat (211 DPI), image | 14.5 g/m² (solid) | | |
| | 10′ flash off, 10′ curing at | Catalyst ink: | | |
| | 180° C. in recirculating drying | 0.44 g/m² | | |
| | cabinet, wash off excess | | | |
| | isocyanate ink with butyl | | | |
| | acetate | | | |
| 18 | Layer 1: cat (211 DPI), | Calculated application | A severely | |
| | image | weight: Isocyanate ink: | distorted | |
| | Layer 2: isocyanate ink | 20.7 g/m² (wet) | image is | |
| | (1400 DPI), full | 14.5 g/m² (solid) | obtained | |
| | surface | Catalyst ink: | | |
| | 10′ flash off, 10′ curing at | 0.44 g/m² | | |
| | 180° C. in recirculating drying | | | |
| | cabinet, wash off excess | | | |
| | isocyanate ink with butyl | | | |
| | acetate | | | |
| 19 | Layer 1: isocyanate ink | Calculated application | A slightly | |
| | (1400 DPI), image | weight: Isocyanate ink: | distorted | |
| | Layer 2: cat (211 DPI), | 20.7 g/m² (wet) | image is | |
| | full surface | 14.5 g/m² (solid) | obtained | |
| | 10′ flash off, 10′ curing at | Catalyst ink: | | |
| | 180° C. in recirculating drying | 0.44 g/m² | | |
| | cabinet, wash off excess | | | |
| | catalyst with butyl acetate | | | |

When the Desmodur® N3600 merely undergoes the temperature program about 5.5% of the isocyanate groups are converted (example 2). When the polyisocyanate is first diluted to a solids content of 70% with butyl acetate about 9% of the NCO groups are converted during the flash off and heat treatment steps (example 3). However, in both cases the product remains liquid. Only when a catalyst is employed (comparative examples 4 and 5 and inventive examples 6 to 15) are tack-free films obtained.

It is apparent from the examples that conversions of at least 50% are achievable independently of the sequence of application and up to an application weight (solid) even at a layer thickness of 100 g/m².

Post-curing at room temperature would result in complete conversion of the remaining isocyanate groups too.

Examples 4 to 6 show that comparable results are obtained irrespective of whether the catalyst is previously incorporated or whether said catalyst is initially printed separately with printing of the isocyanate ink occurring only subsequently.

Examples 6 to 9 verify that it can be particularly advantageous to print the catalyst first and to print the isocyanate ink in the second step.

Examples 16 to 19 show that it is also possible to carry out full surface application of one component and only local application of the other component before washing off the uncured proportion. The examples clearly show that image sharpness is always markedly better when the partial coating (for example an image) is applied with the second layer.

1-15. (canceled)

16. A process for coating surfaces containing the steps of
a) applying a polyisocyanate composition A) to a surface;
b) applying a composition B containing at least one crosslinking catalyst B1 to the same surface; and
c) curing the polyisocyanate composition A by catalytic crosslinking of the polyisocyanate composition A;
with the proviso that the process steps a) and b) are performed in any desired sequence or else simultaneously but prior to process step c).

17. The process as claimed in claim 16, wherein the polyisocyanate composition A is applied such that the layer formed thereby has an application weight of not more than 150 g/m².

18. The process as claimed in claim 16, wherein the catalytic crosslinking in process step c) has the result that at least 30% of the isocyanate groups present in the polyisocyanate composition A are converted into isocyanurate structural units.

19. The process as claimed in claim 16, wherein the polyisocyanate composition A contains at least ≥50% by weight of aliphatic polyisocyanates.

20. The process as claimed in claim 16, wherein the process step a) or the process step b) is carried out at least twice.

21. The process as claimed in claim 20, wherein between the repetitions of the process step carried out at least twice the respective other process step is performed at least once.

22. The process as claimed in claim 20, wherein the process step a) is carried out at least twice and in at least two repetitions polyisocyanate compositions A containing different polyisocyanates are applied.

23. The process as claimed in claim 16, wherein the crosslinking catalyst B1 is basic.

24. The process as claimed in claim 23, wherein the composition contains a carboxylate or an alkoxide.

25. The process as claimed in claim 16, wherein the polyisocyanate composition A contains blocked polyisocyanates.

26. The process as claimed in claim 16, wherein the polyisocyanate composition A is applied only to a portion of the surface covered by the composition B or the composition b is applied only to a portion of the surface covered by the polyisocyanate composition A.

27. The process as claimed in claim 16, wherein the process step c) is performed entirely at room temperature and at least 30% of the isocyanate groups react to afford isocyanurates or uretdiones.

28. The process as claimed in claim 16, wherein the curing in process step c) is carried out in two stages with the proviso that the reaction temperature in a process step c1) is 60° C. to 300° C. and in a process step c2) is 10° C. to 59° C.

29. The process as claimed in claim 16, wherein the ratio of the sum of free and reversibly blocked isocyanate groups to the sum of the isocyanate-reactive groups in the reaction mixture that is present on the surface at commencement of the process step c) is at least 3 to 1.

30. A surface coated by the process as claimed in claim 16.
